(19) United States
(12) Patent Application Publication
(10) Pub. No.: US 2023/0289227 A1
(43) Pub. Date: Sep. 14, 2023

(54) Multi-Computer System for Forecasting Data Surges

(71) Applicant: Bank of America Corporation, Charlotte, NC (US)

(72) Inventors: Manu Kurian, Dallas, TX (US); Albena N. Fairchild, Spruce Pine, NC (US); Aeric John Solow, Richardson, TX (US)

(21) Appl. No.: 17/692,864

(22) Filed: Mar. 11, 2022

(51) Int. Cl. G06F 9/50; G06F 11/34; G06F 11/30; G06F 40/40

(52) U.S. Cl. CPC G06F 9/5016; G06F 11/3442; G06F 11/3006; G06F 40/40

(57) ABSTRACT

Arrangements for forecasting data surges are presented. In some aspects, data may be received from, for instance, a computing system internal to an enterprise organization. In some examples, contextual data may be received. The contextual data may be analyzed, with the received data, to identify a score for the received data. Machine learning may be used to identify or determine the score. In some examples, additional data may be received via a plurality of data streams. The additional data may be analyzed to identify topics or trends in data. The topics or trends may be used to identify potential data surges. Machine learning may be used to analyze the data and forecast a potential data surge. In response to forecasting a potential data surge, one or more computing and/or data storage resources may be identified, configured, and deployed to accommodate the forecast potential data surge.

### BACKGROUND

Aspects of the disclosure relate to electrical computers, systems, and devices for forecasting data surges and modifying computing resources to accommodate data surges.

Enterprise organizations often store vast amounts of data. As data continues to grow over time, it may be difficult to understand the value of data or different types of data. In addition, it may be difficult to forecast surges in data that may require additional computing and/or data storage resources. Accordingly, aspects described herein are directed to arrangements for forecasting data surges and efficiently modifying computing resources to accommodate data surges.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with forecasting data surges.

In some aspects, data may be received from, for instance, a computing system internal to an enterprise organization. In some examples, contextual data may be received. The contextual data may be received from a plurality of sources and including sources internal to the enterprise organization and/or sources external to the enterprise organization. The contextual data may be analyzed, with the received data, to identify a score or value for the received data. In some examples, machine learning may be used to identify or determine the score or value.

In some examples, additional data may be received. The additional data may be received via a plurality of data streams. The additional data may be analyzed to identify topics or trends in data. The topics or trends may be used to identify potential data surges. In some examples, machine learning may be used to analyze the data and forecast a potential data surge.

In response to forecasting a potential data surge, one or more computing and/or data storage resources may be identified and configured. The computing and/or data storage resources may be deployed to accommodate the forecast potential data surge.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing data surge forecasting functions in accordance with one or more aspects described herein;

FIGS. 2A-2E depict an illustrative event sequence for implementing data surge forecasting functions in accordance with one or more aspects described herein;

FIG. 3 illustrates an illustrative method for implementing data surge forecasting functions according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, data storage is a critical function for many enterprise organizations. Accordingly, it may be advantageous to understand a value of data and identify or forecast potential data surges in order to modify computing resources to accommodate the data surge.

For instance, as discussed more fully herein, data may be received and a score or value of the data may be determined. In some examples, the score or value may be determined based, at least in part, on contextual data received from a variety of resources (e.g., business organization data, social media data, publicly available news data, or the like). The received data, and associated score, may be stored.

Additional data may be received and evaluated. For instance, data may be evaluated to identify topics, keywords, and the like, that are trends in the data, indicate increased usage or popularity of a topic, or the like. This information, alone with the stored data and associated score, may be used to identify or forecast a potential data surge. If a data surge is forecast, one or more computing and/or data storage resources may be identified, configured and/or deployed to accommodate the potential data surge.

These and various other arrangements will be discussed more fully below.

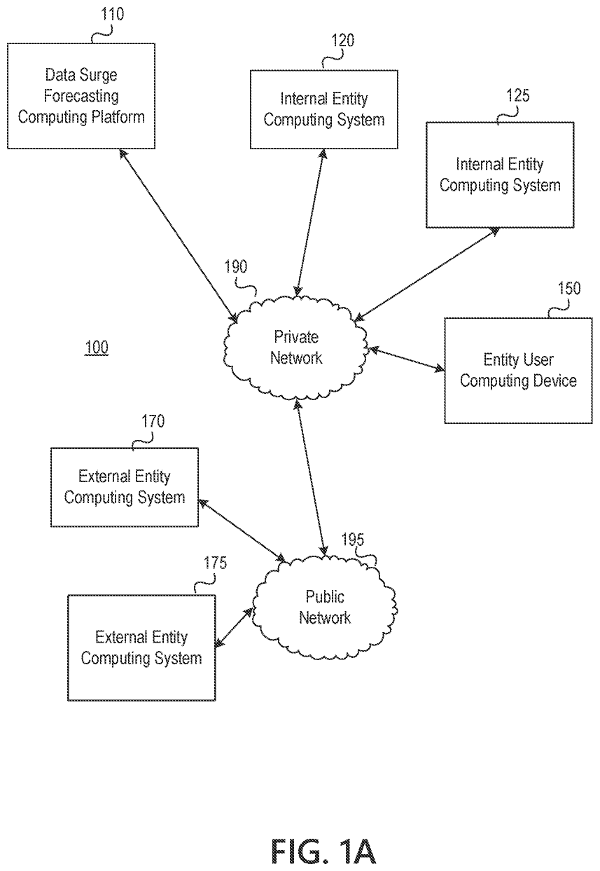

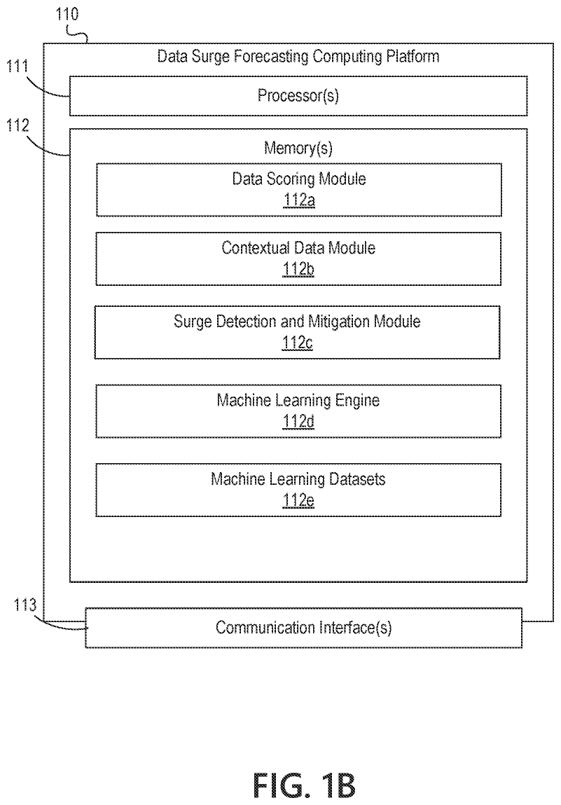

FIGS. 1A-1B depict an illustrative computing environment for implementing and using data surge forecasting functions in accordance with one or more aspects described herein. Referring to FIG. 1A, computing environment 100 may include one or more computing devices and/or other computing systems. For example, computing environment 100 may include data surge forecasting computing platform 110, internal entity computing system 120, internal entity computing system 125, entity user computing device 150, external entity computing system 170 and external entity computing system 175. Although two internal entity computing systems 12,125, one entity user computing device 150, and two external entity computing systems 170, 175 are shown, any number of systems or devices may be used without departing from the invention.

Data surge forecasting computing platform 110 may be configured to perform intelligent, dynamic and efficient data surge functions, as described more fully herein. For instance, data surge forecasting computing platform 110 may receive data from a plurality of sources. For instance, data surge forecasting computing platform 110 may receive data from internal sources (e.g., sources internal to the enterprise organization implementing the data surge forecasting computing platform 110), such as internal entity computing system 120, internal entity computing system 125, or the like, and/or external sources (e.g., sources external to the enterprise organization implementing the data surge forecasting computing platform 110), such as external entity computing system 170, external entity computing system 175, or the like.

In some examples, contextual data associated with one or more data elements may be requested and received. For instance, contextual data from one or more external sources (e.g., external entity computing system 170, external entity computing system 175, or the like) may be requested and/or received. In some arrangements, the contextual data may include data from one or more social media applications, publicly available media outlets, publicly available business data sources, and the like. In some examples, the data may be general data and not associated with a specific user. Additionally or alternatively, the data may include specific user data (e.g., social media data associated with one or more particular users) that is requested and/or received with permission of the user.

In some arrangements, natural language processing (NLP) may be used to evaluate the contextual data and identify categories, topics, or the like, associated with a potential data surge. For instance, NLP may be used to identify trending topics, topics increasing or decreasing in popularity, or the like. In some examples, keyword analysis may be used to identify topics that may be associated with a data surge, may indicate high value data, and the like.

Accordingly, a value or score may be identified for received data. In some examples, a machine learning model trained on historical data associated with high value data, low value data, data topics trends, and the like, may be used to identify a score or value for the received data. The machine learning model may use the data being scored, as well as the received contextual data, NLP outputs, and the like, as inputs in the model to generate a score or value for the data. The data score may then be stored.

Data surge forecasting computing platform 110 may further receive one or more data streams. In some examples, the data streams may be received from one or more internal sources (e.g., internal entity computing system 120, internal entity computing system 125, or the like) and/or external sources, such as external entity computing system 170, external entity computing system 175, or the like. The data streams may be analyzed (e.g., using machine learning models, NLP, and the like) to identify trending topics, topics increasing or decreasing in popularity, or the like. This data may be used to forecast or predict one or more data surges.

For instance, as a topic in identified as increasing in popularity (e.g., based on internal data traffic, external data traffic, or the like), stored data associated with the topic may be identified and a score or value associated with the data may be evaluated. In some examples, if the score is at or above a pre-determined threshold, it may indicate an importance of the data which, in conjunction with the increase in popularity of the associated topic, may indicate an expected data surge. In response to the expected data surge, one or more computing resources, data storage resources, or the like, may be identified and/or deployed. In some examples, data received and associated with that topic may be stored by the newly deployed resources. Accordingly, when popularity of the topic decreases, data may be consolidated, compresses, duplicate data may be deleted, and the like, and the resources may be redeployed to handle a subsequent data surge.

Computing environment 100 may further include internal entity computing system 120 and internal entity computing system 125. Internal entity computing system 120 and/or internal entity computing system 125 may be systems internal to or associated with the enterprise organization implementing the data surge forecasting computing platform 110 and may include one or more computing devices configured to execute or host one or more applications associated with the enterprise organization, store data associated with the organization, employees of the organization, customers of the organization, and the like. For instance, internal entity computing system 120 and/or internal entity computing system 125 may execute or host one or more applications providing services to customers, such as payment systems, mobile or online banking systems, or the like, may execute or host one or more applications enabling business functions (e.g., payroll processing, document retention, and the like), or other functions associated with the enterprise organization.

Entity user computing device 150 may include one or more computing devices (e.g., laptop computing devices, desktop computing devices, or the like) that may be associated with the enterprise organization and may be used to configure or control one or more aspects of data surge forecasting computing platform 110. For instance, entity user computing device 150 may be used to control or configure rules associated thresholds for detecting a surge, identification of resources for deployment, and the like.

External entity computing system 170 and/or external entity computing system 175, and the like may be one or more computing systems associated with an entity other than the enterprise organization. In some examples, the external entity computing system 170 and/or external entity computing system 175 may receive and/or store data from one or more external sources. For instance, external entity computing system 170 may be a payment processing system and may store data associated with processed payments. Additionally or alternatively, external entity computing system 170 and/or external entity computing system 175 may host or execute one or more social media platforms. In still further examples, external entity computing system 170 and/or external entity computing system 175 may store or host publicly available data associated with business information (e.g., financial markets, currency rates, and the like), environmental conditions (e.g., expected weather events, and the like), publicly available new data, and the like. In some examples, and with appropriate permissions when handling user specific data, data may be transmitted from the external entity computing system 170 and/or external entity computing system 175 to the data surge forecasting computing platform 110 for evaluation and/or use in identifying a score or value for data, identifying potential data surges, and the like. In some examples, data may be transmitted from external entity computing system 170 and/or external entity computing system 175 in one or more data streams (e.g., continuous data streams). Additionally or alternatively, data may be transferred in batches.

As mentioned above, computing environment 100 also may include one or more networks, which may interconnect one or more of data surge forecasting computing platform 110, internal entity computing system 120, internal entity computing system 125, entity user computing device 150, external entity computing system 170 and/or external entity computing system 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, data surge forecasting computing platform 110, internal entity computing system 120, internal entity computing system 125, entity user computing device 150, may be associated with an enterprise organization (e.g., a financial institution), and private network 190 may be associated with and/or operated by the organization, and may include one or more networks (e.g., LANs, WANs, virtual private networks (VPNs), or the like) that interconnect data surge forecasting computing platform 110, internal entity computing system 120, internal entity computing system 125, entity user computing device 150, and one or more other computing devices and/or computer systems that are used by, operated by, and/or otherwise associated with the organization. Public network 195 may connect private network 190 and/or one or more computing devices connected thereto (e.g., data surge forecasting computing platform 110, internal entity computing system 120, internal entity computing system 125, entity user computing device 150) with one or more networks and/or computing devices that are not associated with the organization. For example, external entity computing system 170 and/or external entity computing system 175, might not be associated with an organization that operates private network 190 (e.g., because external entity computing system 170 and/or external entity computing system 175 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 170 and/or external entity computing system 175 to private network 190 and/or one or more computing devices connected thereto (e.g., data surge forecasting computing platform 110, internal entity computing system 120, internal entity computing system 125, entity user computing device 150).

Referring to FIG. 1B, data surge forecasting computing platform 110 may include one or more processors 111, memory 112, and communication interface 113. A data bus may interconnect processor(s) 111, memory 112, and communication interface 113. Communication interface 113 may be a network interface configured to support communication between data surge forecasting computing platform 110 and one or more networks (e.g., private network 190, public network 195, or the like). Memory 112 may include one or more program modules having instructions that when executed by processor(s) 111 cause data surge forecasting computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of data surge forecasting computing platform 110 and/or by different computing devices that may form and/or otherwise make up data surge forecasting computing platform 110.

For example, memory 112 may have, store and/or include data scoring module 112a. Data scoring module 112a may store instructions and/or data that may cause or enable the data surge forecasting computing platform 110 to receive data from a plurality of sources (e.g., internal sources, external sources, and the like) and score or determine a value associated with the data. In some examples, data usage may be monitored to score data (e.g., more frequently used data may have a higher score or may be considered more valuable than lesser used data). In some examples, machine learning may be used to score the data. For instance, a machine learning model trained using historical data related to data value or scores may be used to determine a value or score for the data.

In some examples, determining a value or score may further be based on contextual data, such as social media data, publicly available data, internal business data of the enterprise organization, and the like. Accordingly, data surge forecasting computing platform 110 may further have, store and/or include contextual data module 112b. Contextual data module 112b may store instructions and/or data that may cause or enable the data surge forecasting computing platform 110 to receive data from a plurality of sources, evaluate the data (e.g., using NLP, machine learning, and the like) to identify data associated with the received data that may be indicative of data value, and use that information for determining or identifying a value or score. In some examples, contextual data may include data related to a user's relationships within the enterprise organization or role within the enterprise organization (e.g., job title, access level, connections, customer interactions, and the like).

Additionally or alternatively, contextual data module 112b may, after scoring data, receive (e.g., via data streams, batch data, or the like) data from one or more internal sources (e.g., internal entity computing system 120, internal entity computing system 125) and/or external sources (e.g., external entity computing system 170, external entity computing system 175) that may be analyzed (e.g., using NLP, machine learning, and the like) to identify, forecast or detect potential data surges. For instance, keywords that frequently appear in data streams or batches may indicate a potential data surge.

Data surge forecasting computing platform 110 may further have, store and/or include surge detection and mitigation module 112c. Surge detection and mitigation module 112c may store instructions and/or data that may cause or enable the data surge forecasting computing platform 110 to execute one or more machine learning models hosted by machine learning engine 112d. The received data, data score or value, and received streaming or batch data may be used as inputs in the machine learning model to determine whether a potential data surge is forecast or expected. If so, one or more mitigating actions may be identified and executed. For instance, additional computing resources, data storage resources, and the like, may be identified, configured and/or deployed to handle the potential data surge. In some examples, a data category may be identified based on the data and/or the streaming or batch data. In some examples, data may be stored according to the category and the newly identified and/or deployed resources may be configured to receive incoming data associated with the identified category. Accordingly, after a predetermined time period, after data associated with the category drops below a threshold, or the like, the data stored in the newly deployed resources may be combined, compressed, duplicate data deleted, and the like, and resources no longer needed may be redeployed for a subsequent data surge.

Data surge forecasting computing platform 110 may have, store and/or include a machine learning engine 112d storing one or more machine learning datasets 112e. Machine learning engine 112d may train, execute, update and/or validate a machine learning model. For instance, previously received or historical data may be used to train the machine learning model (e.g., via supervised learning, unsupervised learning, or the like). For instance, the machine learning model may be trained using labelled data which may, e.g., include historical data corresponding to various values or scores (e.g., data scored between 1 and 10, 1 and 100, or the like), historical data linking contextual data (e.g., business value data, biographic data, and the like), type of data (e.g., data category), and/or keywords to data scores or values, historical data linking keywords or data trends to data surges, and the like. Accordingly, data may be scored or a value determined based on multiple factors, connections, contexts, and the like. For instance, a particular type of data (e.g., address data) in a first context (e.g., evaluating home values) may have a higher score than the first type of data (e.g., address data) in a second, different context (e.g., evaluating mobile application usage). Machine learning datasets 112e linking or identifying these patterns or sequences may be used to identify a score or value for data.

Various machine learning algorithms may be used (e.g., by the machine learning engine 112d and/or the one or more machine learning models) without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

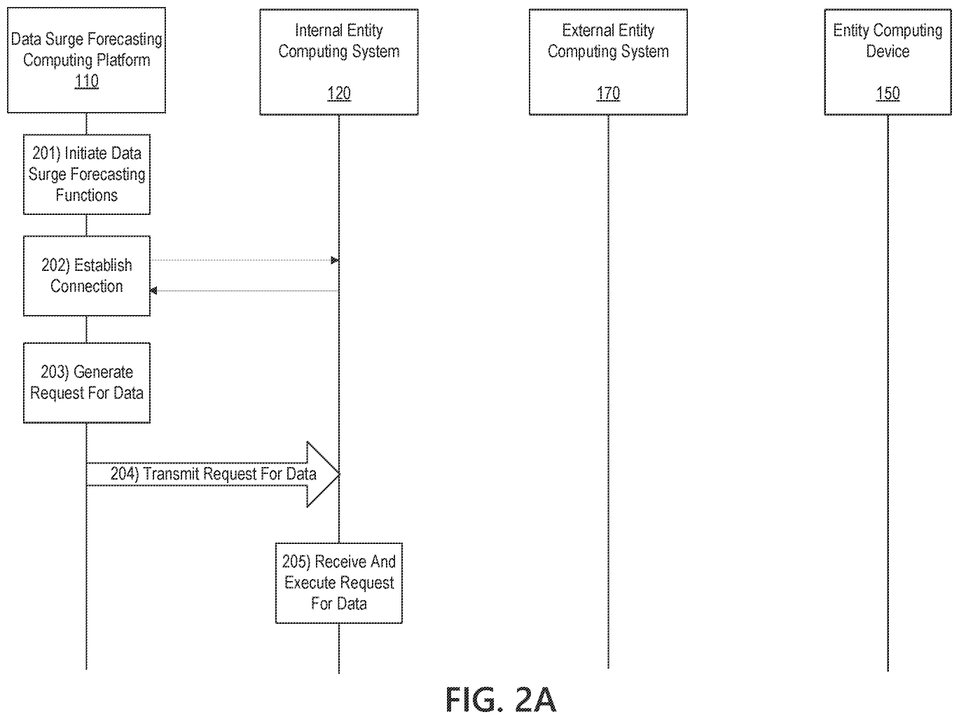

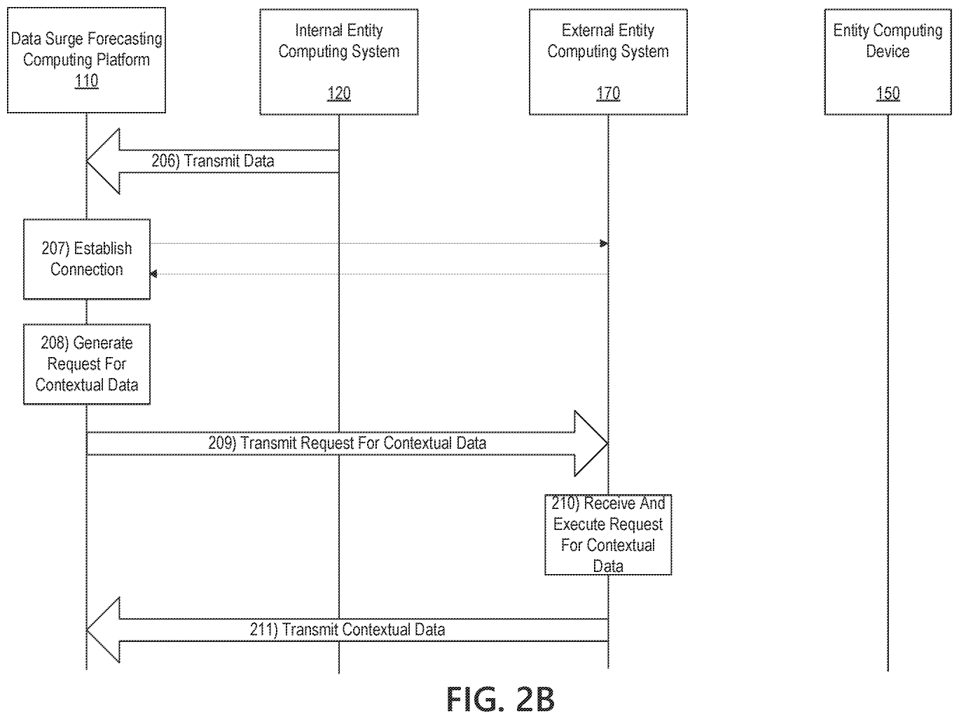

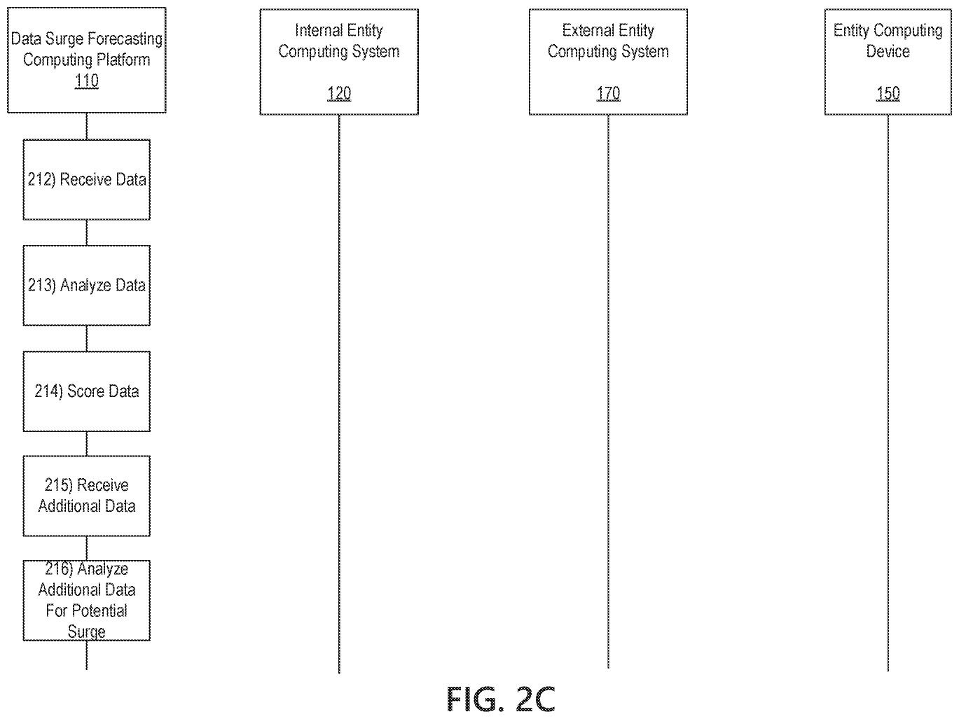

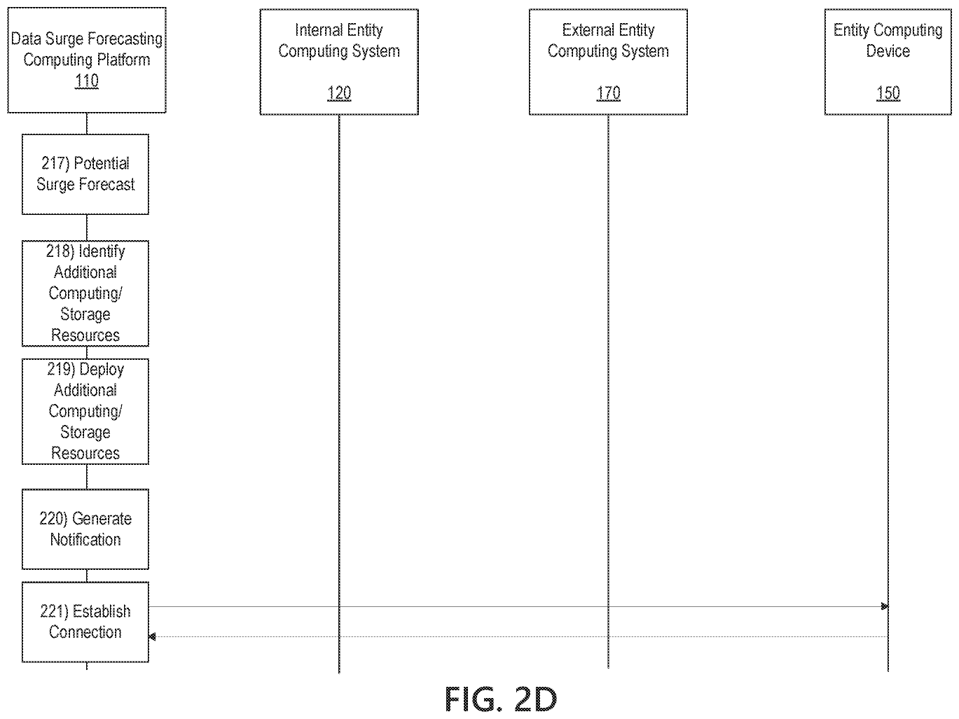

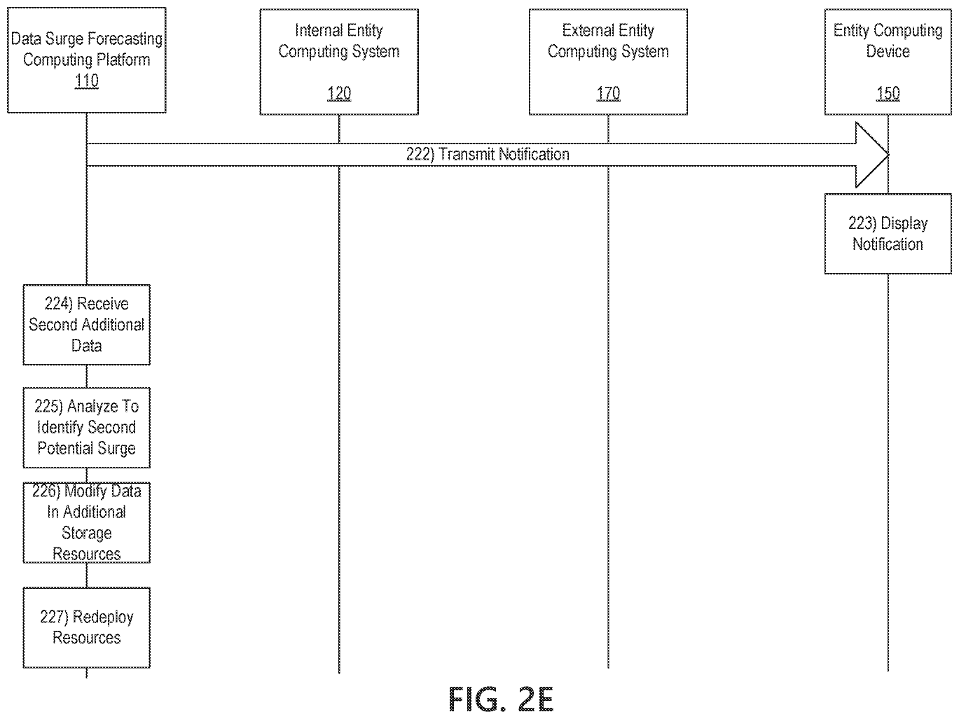

FIGS. 2A-2E depict one example illustrative event sequence for using data surge forecasting functions in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, data surge forecasting computing platform 110 may initiate or activate one or more data surge forecasting functions. For instance, data surge forecasting computing platform 110 may initiate or activate one or more functions for receiving data from various sources (e.g., internal entity computing system 120, external entity computing system 170, or the like), executing a machine learning model, scoring or valuing data, identifying potential data surges, identifying computing or data storage resources, deploying computing and/or data storage resources, and the like. In some examples, the functions may be initiated in response to an attempt to transmit data from a device to the data surge forecasting computing platform 110, to a request to transmit data, to an instruction to request data from one or more sources, and the like.

At step 202, data surge forecasting computing platform 110 may establish a connection with internal entity computing system 120. For instance, a first wireless connection may be established between the data surge forecasting computing platform 110 and internal entity computing system 120. Upon establishing the first wireless connection, a communication session may be initiated between data surge forecasting computing platform 110 and internal entity computing system 120.

At step 203, a request for data may be generated by the data surge forecasting computing platform 110. For instance, a request to receive data from internal entity computing system 120 may be generated. The request may include a request to receive data in a data stream (e.g., continuously receive data or receive streaming data as it is received by the internal entity computing system 120) or receive batch transfers of data at predetermined times, days, or the like.

At step 204, the request for data may be transmitted by the data surge forecasting computing platform 110 to the internal entity computing system 120. For instance, data surge forecasting computing platform 110 may transmit the request for data to the internal entity computing system 120 during the communication session initiated upon establishing the first wireless connection.

At step 205, internal entity computing system 120 may receive the request for data and execute the request. For instance, data at the internal entity computing system 120 may be retrieved and instructions to transmit data subsequently received by the internal entity computing system 120 may be executed.

With reference to FIG. 2B, at step 206, internal entity computing system 120 may transmit the requested data to the data surge forecasting computing platform 110. For instance, internal entity computing system 120 may transmit the requested data during the communication session initiated upon establishing the first wireless connection.

At step 207, data surge forecasting computing platform 110 may establish a connection with external entity computing system 170. For instance, a second wireless connection may be established between the data surge forecasting computing platform 110 and external entity computing system 170. Upon establishing the second wireless connection, a communication session may be initiated between data surge forecasting computing platform 110 and external entity computing system 170.

At step 208, a request for contextual data may be generated by the data surge forecasting computing platform 110. For instance, a request to receive contextual data from external entity computing system 170 may be generated. The request may include a request to receive data in a data stream (e.g., continuously receive data or receive streaming data as it is received by the internal entity computing system 120) or receive batch transfers of data at predetermined times, days, or the like. Although FIG. 2B illustrates one request for contextual data being transmitted to one external entity computing system 170, additional requests for contextual data may be transmitted to one or more additional external entity computing systems, as well as one or more internal entity computing systems, without departing from the invention.

At step 209, the request for contextual data may be transmitted by the data surge forecasting computing platform 110 to the external entity computing system 170. For instance, data surge forecasting computing platform 110 may transmit the request for contextual data to the external entity computing system 170 during the communication session initiated upon establishing the second wireless connection.

At step 210, external entity computing system 170 may receive the request for contextual data and execute the request. For instance, data at the external entity computing system 170 may be retrieved and instructions to transmit data subsequently received by the external entity computing system 170 may be executed.

At step 211, external entity computing system 170 may transmit the requested contextual data to the data surge forecasting computing platform 110. For instance, external entity computing system 170 may transmit the requested contextual data during the communication session initiated upon establishing the second wireless connection.

With reference to FIG. 2C, at step 212, the data surge forecasting computing platform 110 may receive data from the internal entity computing system 120 and/or the external entity computing system 170. Although the arrangements shown depict receiving data from one internal entity computing system 120 and one external entity computing system 170, data may be received from multiple systems in parallel without departing from the invention.

In some examples, the data may include data related to customer activity. For instance, payment data associated with one or more payments made by users (e.g., loan payments, mortgage payments, bill payments, and the like). Further, various other types of customer data may be received (e.g., with permission of the user) without departing from the invention.

At step 213, the received data may be analyzed. For instance, machine learning may be used to analyze the data, score or value the data, identify a type of data, and the like. As discussed herein, a machine learning model trained on historical data may be executed to analyze the received data. For instance, data received from the internal entity computing system 120 may be scored or a value determined by executing a machine learning model. The data (e.g., customer data, purchase data, or the like) may be input into the model. In some examples, the received contextual data may be used as inputs as well. The machine learning model may be executed to evaluate the contextual data and data received from internal entity computing system 120 to determine or identify a score or value for the data. Accordingly, contextual data, such as enterprise organization or other business data, social media data, publicly available data, and the like, may be mined using natural language processing, keywork searching, or the like, to identify connections or topics related to the data being scored. That data may then be used to determine or identify a value or score for the data based on frequency of use of the data or type of data, trending topics, number of social or business connections, and the like.

At step 214, the received data (e.g. from internal entity computing system 120) may, in some examples, be scored or a value of the data determined and the data may be stored (e.g., with the score and, in some examples, an identified category or type of data). For instance, the received data may be input into the machine learning model and a score of the data may be identified or determined. In some examples, the score may be based on data usage, criticality of the data, frequency of data being received, contextual data, business interests or connections, and the like. The machine learning model may, as discussed herein, be trained on historical data related to one or more of these factors and, accordingly, may evaluate the received data and generate or identify an appropriate score or value for the data.

At step 215, additional data may be received. For instance, additional streaming or batch data may be received from one or more of internal entity computing system 120, external entity computing system 170, or the like. The additional data may include additional data related to the enterprise organization (e.g., from internal entity computing system 120) and/or related to additional contextual data, such as social media data, publicly available new or business data, and the like.

At step 216, the additional data may be evaluated (e.g., using natural language processing, keyword searching, or the like) to identify stored data related to the additional data and determine whether a potential data surge is forecast. For instance, stored data that is identified as related to the additional data (e.g., based on topic, or the like) may be identified and a score associated with that data may be retrieved. Accordingly, based on the evaluation of the additional data (e.g., volume of data, frequency of keyword or topic appearance, or the like), as well as the score associated with the stored data (e.g., a higher score indicating greater importance or value than a lower score), a determination regarding whether a potential data surge should be forecast may be made. In some examples, the machine learning model may be used to evaluate the additional data, the score of the related stored data, and the like, to identify a potential data surge.

With reference to FIG. 2D, at step 217, a determination may be made that a potential data surge is forecast by the data surge forecasting computing platform 110.

At step 218, additional computing and/or data storage resources may be identified to accommodate the potential data surge. For instance, additional computing devices, servers, or the like, to analyze the incoming data, as well as additional data storage capacity may be identified based on the potential data surge.

At step 219, the additional computing and/or data storage resources may be commissioned or configured to accommodate the potential data surge and deployed (e.g., put online, instructed to captured/analyze incoming data, and the like).

At step 220, a notification may be generated. For instance, data surge forecasting computing platform 110 may generate a notification indicating that a potential data surge is forecast, identifying additional resources deployed, and the like.

At step 221, a connection may be established between the data surge forecasting computing platform 110 and the entity computing device 150. For instance, a third wireless connection may be established between the data surge forecasting computing platform 110 and entity computing device 150. Upon establishing the third wireless connection, a communication session may be initiated between data surge forecasting computing platform 110 and entity computing device 150.

With reference to FIG. 2E, at step 222, the generated notification may be transmitted by the data surge forecasting computing platform 110 to the entity computing device 150. For instance, the notification may be transmitted during the communication session initiated upon establishing the third wireless connection.

At step 223, the notification may be displayed by a display of the entity computing device 150.

At step 224, second additional data may be received. For instance, second additional data from one or more internal sources and/or external sources may be received by the data surge forecasting computing platform 110.

At step 225, the second additional data may be analyzed to identify a second potential data surge. For instance, similar to arrangements discussed above, the second additional data may be analyzed, e.g., using machine learning, to identify a second topic or category in which a data surge may occur. Based on the evaluation, a second data surge may be forecast.

At step 226, data stored by the additional data storage resources deployed in response to the initial identified data surge may be modified. For instance, data in the additional resources may be combined, compressed, duplicate data deleted, and the like. In some examples, the modified data may be moved to an alternate data storage location.

At step 227, the additional computing and/or data storage resources may be redeployed to accommodate the second forecast data surge.

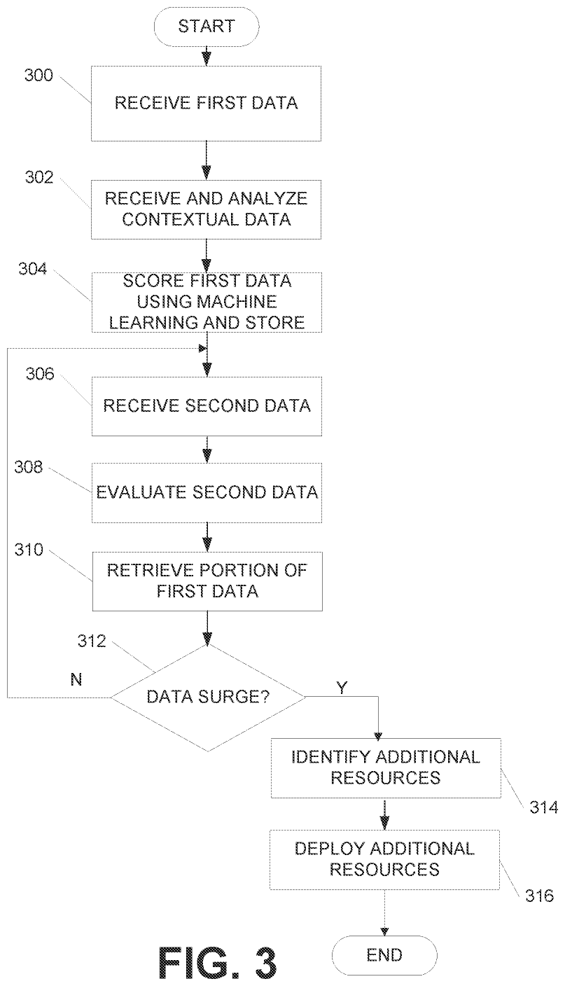

FIG. 3 is a flow chart illustrating one example method of implementing data surge forecasting functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, first data may be received. For instance, first data from a data source internal to an enterprise organization implementing a data surge forecasting computing platform may be received by the data surge forecasting computing platform 110. The first data may include customer data, data associated with business operations of the enterprise organization, employee data of the employees of the enterprise organization, and the like. In some examples, the first data may include a single data element. Additionally or alternatively, the first data may include a plurality of data elements.

At step 302, contextual data may be received. For instance, contextual data from one or more sources internal to the enterprise organization and/or external to the enterprise organization may be received. The contextual data may include data associated with organizational structure of the enterprise organization, associated and customer relationships for the enterprise organization, social media data, publicly available news and business data, and the like. The contextual data may be analyzed (e.g., mined for topics using, for instance, natural language processing, keyword searching, and the like) to aid in determining a score or value associated with the first data.

At step 304, a machine learning model may be executed to determine a score for the first data. For instance, the first data, as well as the contextual data and/or results of analysis of the contextual data may be used as inputs in a machine learning model. The machine learning model may then output a score or value for the first data. The first data and associated score may be stored by the data surge forecasting computing platform 110. In some examples, the data may be stored in a data container associated with a topic, type of data, category of data, or the like (e.g., data may be tagged when stored). Accordingly, in arrangements in which a surge is forecast, a data container associated with the data surge, topic of the data surge, type of data in the surge, category of data in the surge, or the like, may be identified and additional resources provided for that data container (e.g., increased computer processing, increased memory, or the like).

At step 306, second data may be received. For instance, second data may be received from a plurality of sources (e.g., sources internal to the enterprise organization, sources external to the enterprise organization, and the like). In some examples, the second data may be received via a plurality of data streams.

At step 308, the second data may be evaluated. For instance, natural language processing or other techniques may be used to mine the second data to identify data topics within the second data related to one or more categories of stored data. For instance, the second data may be evaluated to identify topics associated with the stored first data.

At step 310, a portion of the stored first data, and any associated score, may be retrieved based on the evaluation of the second data.

At step 312, a determination may be made as to whether a data surge is forecast. For instance, the analyzed second data, as well as the retrieved portion of the stored first data and associated score may be used to determine whether a data surge is forecast and a topic associated with the surge. For instance, the evaluated second data may indicate topics that are trending, having volumes of data above a threshold being transferred to used, frequently mentioned terms, and the like. This information may be used with the retrieved portion of the first data and the score (e.g., score indicating whether the data is high value data or lower value data) to determine whether a data surge is forecast. In some examples, a machine learning model may use the evaluated second data, retrieved portion of the first data, and score as inputs to determine whether a data surge is forecast.

If, at step 312, a data surge is not forecast, the process may return to step 306 to receive additional data.

If, at step 312, a data surge is forecast, additional computing and/or data storage resources may be identified and configured at step 314. For instance, additional computing resources and/or data storage resources to accommodate the forecast data surge may be identified and configured.

At step 316, the identified additional computing and/or data storage resources may be deployed.

The arrangements described herein enable efficient evaluation of data to understand value of data and efficiently identify potential data surges that may require additional computing and/or data storage resources. As data is received, a score may be determined for the data. In some examples, the score may be based, at least in part, on contextual data. Additional data may be received and analyzed to identify one or more topics or trends in the data. In some examples, machine learning may be used to evaluate the identified topics or trends, the received data and associated score to determine whether a potential data surge is forecast. If so, additional computing and/or data storage resources may be identified.

In one example arrangement, data may be received for a user. The data may include user payment data and the like. The data may be evaluated, e.g., using contextual data, to score the data. Subsequently, additional data may be received. The additional data may be publicly available data associated with data related to the user or the user payment data. Accordingly, the user payment data may be retrieved, along with the score, to understand whether a data surge may occur. In some examples, the value or score of the data may be used to identify potential surges. For instance, the score may be compared to one or more thresholds to understand a value or importance of the data. Data having greater importance (e.g., higher score or score above a threshold) may indicate that a data surge is likely to occur (e.g., because the data is valuable) and, if so, the enterprise organization should ramp up resources to accommodate the surge.

Alternatively, if the data has less importance (e.g., score below the threshold), it may be less likely that a data surge will occur (e.g., because less importance may indicate fewer entities are using the data, fewer entities show interest in the data, or the like) and/or that, if a data surge should occur, capturing and/or evaluating all data is of less interest to the enterprise organization because of the lack of importance.

Accordingly, topics in the received data may be used to identify stored data and an associated score to determine whether a potential data surge will occur. In some examples, one or more connections between types of data, data categories, or the like, may be identified and stored to link data, data scores, and the like.

As discussed herein, data analyzed to identify potential data surges may be received from one or more internal computing systems (e.g., internal entity computing system 120, internal entity computing system 125) and/or one or more external computing systems (e.g., external entity computing system 170, external entity computing system 175). In some examples, the data may be received on a continuous basis (e.g., in one or more data streams) to constantly monitor data to understand trends, topics of popularity, and the like.

In some examples, identifying or forecasting a potential data surge may include identifying an application hosted or executed by the enterprise organization that may be impacted by the surge. For instance, in some examples, a potential data surge may impact an online banking system. Accordingly, upon forecasting a potential data surge, the central processing unit (CPU), random access memory (RAM), instances of the application, or the like may be enhanced, increased, or the like, to accommodate the anticipated data surge.

Further, as discussed herein, the use of contextual data to determine a score may enable identification of value of data in different contexts. For instance, data may have greater value to an enterprise organization in a first industry than an enterprise organization in a second, different industry. Accordingly, contextual storing enables a customized understanding of value of data to an organization or entity.

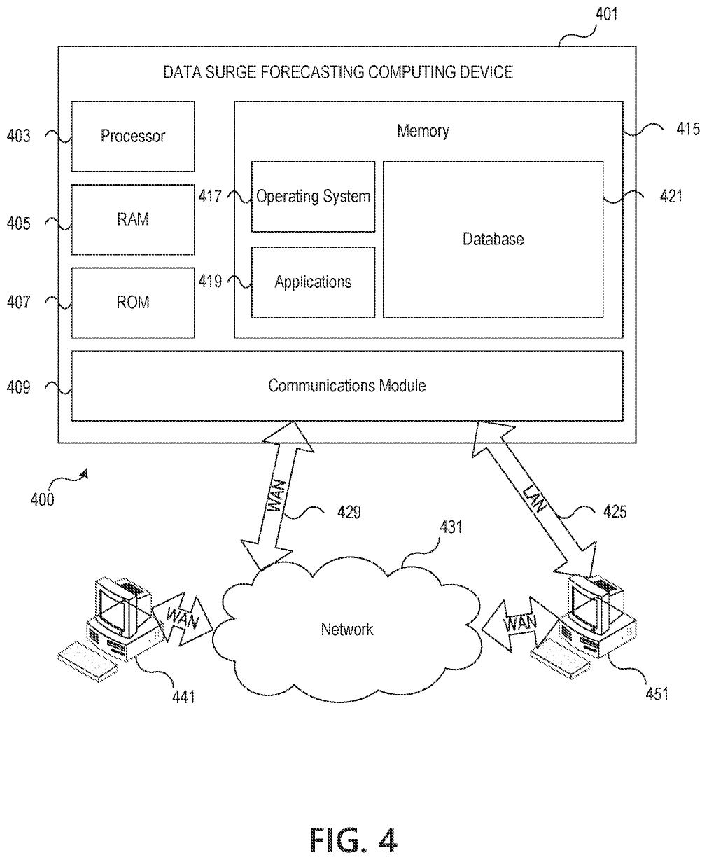

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include data surge forecasting computing device 401 having processor 403 for controlling overall operation of data surge forecasting computing device 401 and its associated components, including Random Access Memory (RAM) 405, Read-Only Memory (ROM) 407, communications module 409, and memory 415. Data surge forecasting computing device 401 may include a variety of computer readable media. Computer readable media may be any available media that may be accessed by data surge forecasting computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by data surge forecasting computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on data surge forecasting computing device 401. Such a processor may execute computer-executable instructions stored on a computer-readable medium.

Software may be stored within memory 415 and/or storage to provide instructions to processor 403 for enabling data surge forecasting computing device 401 to perform various functions as discussed herein. For example, memory 415 may store software used by data surge forecasting computing device 401, such as operating system 417, application programs 419, and associated database 421. Also, some or all of the computer executable instructions for data surge forecasting computing device 401 may be embodied in hardware or firmware. Although not shown, RAM 405 may include one or more applications representing the application data stored in RAM 405 while data surge forecasting computing device 401 is on and corresponding software applications (e.g., software tasks) are running on data surge forecasting computing device 401.

Communications module 409 may include a microphone, keypad, touch screen, and/or stylus through which a user of data surge forecasting computing device 401 may provide input, and may also include one or more of a speaker for providing audio output and a video display device for providing textual, audiovisual and/or graphical output. Computing system environment 400 may also include optical scanners (not shown).

Data surge forecasting computing device 401 may operate in a networked environment supporting connections to one or more remote computing devices, such as computing devices 441 and 451. Computing devices 441 and 451 may be personal computing devices or servers that include any or all of the elements described above relative to data surge forecasting computing device 401.

The network connections depicted in FIG. 4 may include Local Area Network (LAN) 425 and Wide Area Network (WAN) 429, as well as other networks. When used in a LAN networking environment, data surge forecasting computing device 401 may be connected to LAN 425 through a network interface or adapter in communications module 409. When used in a WAN networking environment, data surge forecasting computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive first data;
receive contextual data;
analyze the contextual data using natural language processing to identify portions of the contextual data related to the first data;
score, using a machine learning model and based on the analyzed contextual data and the first data, the first data;
store the first data and associated score;
receive, from a plurality of data feeds, second data;
analyze the second data to identify topics associated with a potential data surge;
retrieve a portion of data from the first data associated with the identified topics and a respective score for the portion of data from the first data;
determine, based on the analyzing the second data, the retrieved portion of data and respective score, whether a data surge is forecast;
responsive to determining that a data surge is not forecast, continuing to receive additional data from the plurality of data feeds;
responsive to determining that a data surge is forecast:
identify one or more computing or data storage resources to accommodate the forecast data surge; and
deploy the identified one or more computing or data storage resources.

2. The computing platform of claim 1, wherein analyzing the second data to identify topics associated with a potential data surge includes analyzing the second data using natural language processing.

3. The computing platform of claim 1, wherein determining whether a data surge is forecast is performed using the machine learning model.

4. The computing platform of claim 1, wherein the machine learning model is trained using historical data.

5. The computing platform of claim 1, wherein the first data is received from a source internal to an enterprise organization implementing the computing platform.

6. The computing platform of claim 1, wherein the contextual data includes data received from sources internal to an enterprise organization implementing the computing platform and external to the enterprise organization.

7. The computing platform of claim 6, wherein the contextual data includes organizational data of the enterprise organization, social media data, and publicly available news data.

8. The computing platform of claim 1, wherein the second data is received from sources internal to an enterprise organization implementing the computing platform and external to the enterprise organization.

9. A method, comprising:
receiving, by a computing platform, the computing platform having at least one processor and memory, first data;
receiving, by the at least one processor, contextual data;
analyzing, by the at least one processor, the contextual data using natural language processing to identify portions of the contextual data related to the first data;
scoring, by the at least one processor, using a machine learning model and based on the analyzed contextual data and the first data, the first data;
storing the first data and associated score;
receiving, by the at least one processor and from a plurality of data feeds, second data;
analyzing, by the at least one processor, the second data to identify topics associated with a potential data surge;
retrieving, by the at least one processor, a portion of data from the first data associated with the identified topics and a respective score for the portion of data from the first data;
determining, by the at least one processor and based on the analyzing the second data, the retrieved portion of data and respective score, whether a data surge is forecast;
when it is determined that a data surge is not forecast, continuing to receive, by the at least one processor, additional data from the plurality of data feeds;
when it is determined that a data surge is forecast:
identifying, by the at least one processor, one or more computing or data storage resources to accommodate the forecast data surge; and
deploying, by the at least one processor, the identified one or more computing or data storage resources.

10. The method of claim 9, wherein analyzing the second data to identify topics associated with a potential data surge includes analyzing the second data using natural language processing.

11. The method of claim 9, wherein determining whether a data surge is forecast is performed using the machine learning model.

12. The method of claim 9, wherein the machine learning model is trained using historical data.

13. The method of claim 9, wherein the first data is received from a source internal to an enterprise organization implementing the computing platform.

14. The method of claim 9, wherein the contextual data includes data received from sources internal to an enterprise organization implementing the computing platform and external to the enterprise organization.

15. The method of claim 14, wherein the contextual data includes organizational data of the enterprise organization, social media data, and publicly available news data.

16. The method of claim 9, wherein the second data is received from sources internal to an enterprise organization implementing the computing platform and external to the enterprise organization.

17. One or more non-transitory computer-readable media storing instructions that, when executed by a computing platform comprising at least one processor, memory, and a communication interface, cause the computing platform to:
receive first data;
receive contextual data;
analyze the contextual data using natural language processing to identify portions of the contextual data related to the first data;
score, using a machine learning model and based on the analyzed contextual data and the first data, the first data;
store the first data and associated score;
receive, from a plurality of data feeds, second data;
analyze the second data to identify topics associated with a potential data surge;
retrieve a portion of data from the first data associated with the identified topics and a respective score for the portion of data from the first data;
determine, based on the analyzing the second data, the retrieved portion of data and respective score, whether a data surge is forecast;
responsive to determining that a data surge is not forecast, continuing to receive additional data from the plurality of data feeds;
responsive to determining that a data surge is forecast:
identify one or more computing or data storage resources to accommodate the forecast data surge; and
deploy the identified one or more computing or data storage resources.

18. The one or more non-transitory computer-readable media of claim 17, wherein analyzing the second data to identify topics associated with a potential data surge includes analyzing the second data using natural language processing.

19. The one or more non-transitory computer-readable media of claim 17, wherein determining whether a data surge is forecast is performed using the machine learning model.

20. The one or more non-transitory computer-readable media of claim 17, wherein the first data is received from a source internal to an enterprise organization implementing the computing platform.

21. The one or more non-transitory computer-readable media of claim 17, wherein the contextual data includes data received from sources internal to an enterprise organization implementing the computing platform and external to the enterprise organization.

22. The one or more non-transitory computer-readable media of claim 21, wherein the contextual data includes organizational data of the enterprise organization, social media data, and publicly available news data.

23. The one or more non-transitory computer-readable media of claim 17, wherein the second data is received from sources internal to an enterprise organization implementing the computing platform and external to the enterprise organization.
